(19) United States
(12) Patent Application Publication
(10) Pub. No.: US 2023/0034922 A1
(43) Pub. Date: Feb. 2, 2023

(54) SPEAKER VIBRATION ASSEMBLY AND SPEAKER

(71) Applicant: ShenZhen Luxshare Acoustics Technology Ltd., ShenZhen (CN)

(72) Inventor: ZhiHua TONG, SHENZHEN (CN)

(73) Assignee: ShenZhen Luxshare Acoustics Technology Ltd., SHENZHEN (CN)

(21) Appl. No.: 17/872,343

(22) Filed: Jul. 25, 2022

(30) Foreign Application Priority Data
Jul. 27, 2021 (CN) 202121745642.6

(51) Int. Cl. H04R 1/02

(52) U.S. Cl. CPC H04R 1/023; H04R 1/025; H04R 7/04

(57) ABSTRACT

The present disclosure provides a speaker vibration assembly and speaker. The speaker vibration assembly driven by a speaker driving module to vibrate, which comprises a first frame body, a vibrating diaphragm, and a plurality of covering members. The first frame body comprises a hollow part. The vibrating diaphragm is disposed at the first frame body and covers the hollow part. The vibrating diaphragm comprises a plurality of first openings. The plurality of covering members are disposed at the vibrating diaphragm and respectively cover the plurality of first openings. Each of the covering members comprises a plurality of through holes. The speaker comprises a speaker vibration assembly according to the above description and a driving module. The driving module is connected with the first frame body and driving the first frame body to vibrate.

### CROSS-REFERENCE TO RELATED APPLICATION

This application claims the priority benefit of Chinese Patent Application Serial Number 202121745642.6, filed on Jul. 27, 2021, the full disclosure of which is incorporated herein by reference.

### BACKGROUND

### Technical Field

The present disclosure relates to the technical field of speaker vibration assembly, particularly to a speaker vibration assembly and a speaker whose vibrating diaphragm is provided with an opening so that the air inside and outside the speaker could circulate for heat dissipation.

### Related Art

In conventional speakers comprising magnet and coil, a magnetic field is generated when an electric current passes the coil to attract or repel the magnetic field of the magnet so that the coil could reciprocate to attach to and detach from the magnet. When the coil reciprocates, a vibrating assembly vibrates along with the movement of the coil and vibrates the air to generate sound waves for the speaker to sound. Since conventional vibrating diaphragm isolates internal air from that outside of the speaker, the heat generated during the operation inside the speaker could not be conducted to the outside, resulting in poor heat dissipation of the speaker.

### SUMMARY

The embodiments of the present disclosure provide a speaker vibration assembly and a speaker tended to solve the problem in the prior art of poor heat dissipation since the vibration diaphragm blocks the internal air from air outside of the speaker.

The present disclosure provides a speaker vibration assembly driven by a speaker driving module to vibrate, comprising a first frame body, a vibrating diaphragm, and a plurality of covering members. The first frame body comprises a hollow part. The vibrating diaphragm is disposed at the first frame body and covers the hollow part. The vibrating diaphragm comprises a plurality of first openings. The plurality of covering members are disposed at the vibrating diaphragm and respectively cover the plurality of first openings. Each of the covering members comprises a plurality of through holes.

The present disclosure provides a speaker, comprising a speaker vibration assembly according to above description and a driving module. The driving module is connected with the first frame body and driving the first frame body to vibrate.

In the speaker vibration assembly of the present disclosure, by providing a plurality of first openings on the vibrating diaphragm, and providing a covering member having a plurality of through holes on the first openings, the inner side of the speaker can be communicated with the outer side so that the air inside the speaker could flow to the outer side through the first opening and the plurality of through holes. Thus, the problem of poor heat dissipation of conventional speakers can be solved as the heat generated inside the speaker can be brought to the outside through the convection of the air.

Besides, the first opening of the speaker assembly is provided with a covering member having a plurality of through holes, so that the vibrating diaphragm could maintain structural continuity even a plurality of first openings are provided. When the vibrating diaphragm is driven by the driving module to vibrate, the tension of the vibrating diaphragm could be evenly applied to every position on the vibrating diaphragm. Thus, when the diaphragm is vibrating, every position on the vibrating diaphragm could be evenly displaced to avoid the generated sound wave being distorted compared to the predetermined sound wave that affects the quality of the sound output by the speaker.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a perspective view of a speaker vibration assembly of an embodiment of the present disclosure;

FIG. 2 is an exploded view of the speaker vibration assembly of FIG. 1;

FIG. 3 is a top view of the speaker vibration assembly of FIG. 1;

FIG. 4 is a cross-sectional view along line A-A′ of FIG. 3;

FIG. 5 is a cross-sectional view of a speaker of an embodiment of the present disclosure; and

FIG. 6 is an exploded view of an electrical connector of another embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an ...” does not exclude other same elements existing in the process, the method, the article, or the device which includes the element.

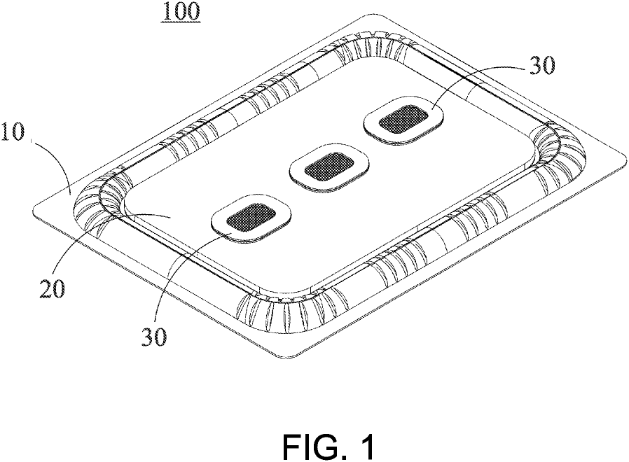

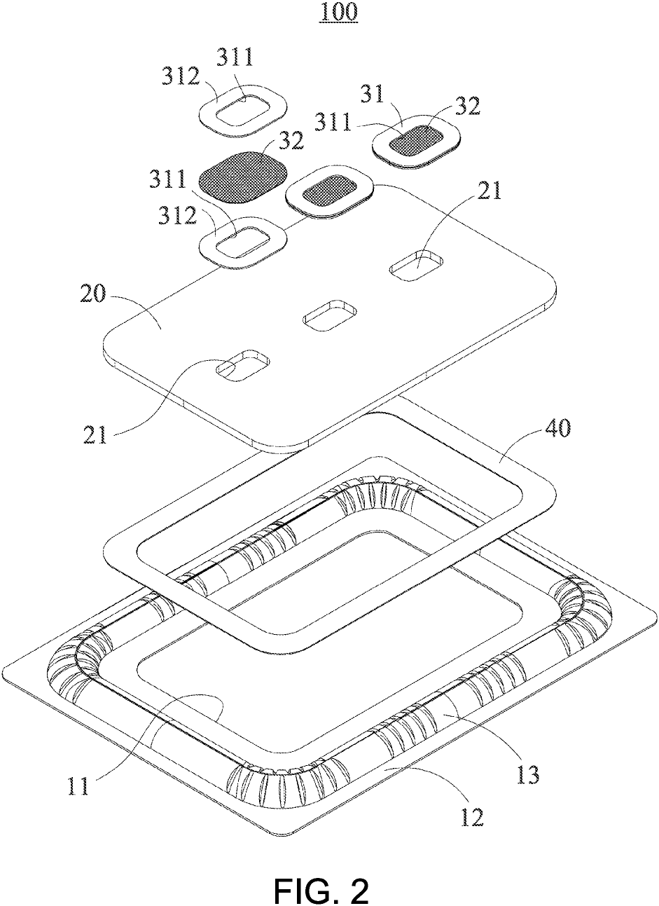

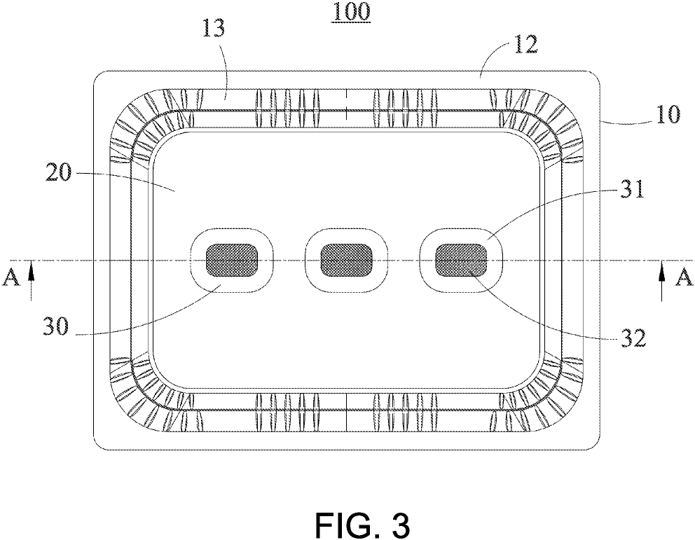

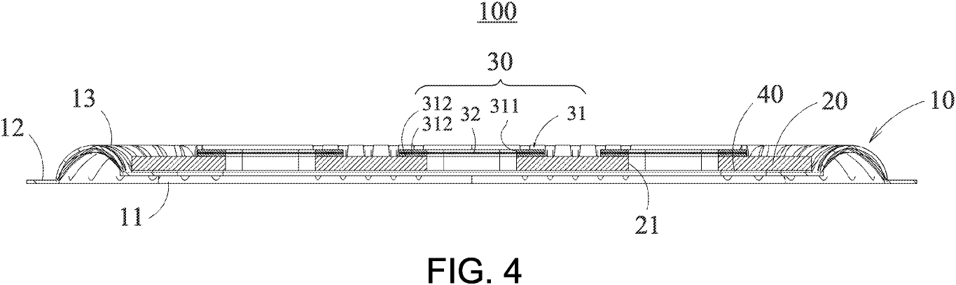

FIG. 1 is a perspective view of a speaker vibration assembly of an embodiment of the present disclosure. FIG. 2 and FIG. 3 are exploded view and top view of the speaker vibration assembly of FIG. 1. FIG. 4 is a cross-sectional view along line A-A′ of FIG. 3. As shown in the figures, in this embodiment, the speaker vibration assembly 100 comprises a first frame body 10, a vibrating diaphragm 20, and a plurality of covering members 30.

As shown in FIG. 2, the first frame body 10 is plate shaped and comprises a hollow part 11 at the center. In this embodiment, the first frame body 10 can be made of metal or plastic, and the hollow part 11 is formed by stamping. The first frame body 10 is elastic to be considered as an elastomer, which is connected with a driving module 200 which would be described hereinafter. The driving module 200 drives the first frame body 10 to reciprocate and vibrate. The first frame body 10 of this embodiment is rectangular, and the hollow part 11 is also rectangular.

As shown in FIG. 1. and FIG. 2, in detail, the first frame body 10 comprises a base 12 and an annular bump 13. The base 12 is plate shaped, at which the hollow part 11 is disposed. The annular bump 13 is disposed at the base 12 and surrounds the hollow part 11. The annular bump 13 can be formed by drawing or stamping. In this embodiment, the cross sectional area of the annular bump 13 is arc shaped. The annular bump 13 is appropriately distant from an edge of the hollow part 11 so that a part of the base 12 between the annular bump 13 and the edge of the hollow part 11 could support the vibrating diaphragm 20.

As shown in FIG. 4, the vibrating diaphragm 20 is disposed at the first frame body 10, which supports the vibrating diaphragm 20. The vibrating diaphragm 20 is disposed at the part of the aforementioned base 12 between the annular bump 13 and the edge of the hollow part 11. An edge of the vibrating diaphragm 20 abuts against the annular bump 13 so that the vibrating diaphragm 20 could cover the hollow part 11. The vibrating diaphragm 20 can be made of composite materials and is elastic. When the first frame body 10 is driven by the driving module 200 to reciprocate, the vibrating diaphragm 20 would reciprocate along with the first frame body 10 to vibrate the air to generate sound waves. In this embodiment, the vibrating diaphragm 20 is provided with a plurality of first openings 21, and the number of the first openings 21 is three, which are linearly arranged on the vibrating diaphragm 20. Generally, The number and arrangement of the first openings 21 are not limited, and the number of the first openings 21 can be more than three or less than three. The first openings 21 can also be in curved arrangement or array arrangement.

In another embodiment, the first frame body 10 can be integrally formed with the vibrating diaphragm 20, for example, an integral configuration formed by injection molding. That is, the vibrating diaphragm 20 is connected with an inner edge of the first frame body 10 and forms an integrated configuration with the first frame body 10.

The speaker vibration assembly 100 of this embodiment further comprises an adhesive layer 40, which is disposed between the vibrating diaphragm 20 and the first frame body 10. The vibrating diaphragm 20 is positioned at the first frame body 10 by the adhesive layer 40. The shape of the adhesive layer 40 is identical to the shape of the part of the base 12 between the annular bump 13 and the edge of the hollow part 11 so that the vibrating diaphragm 20 can be firmly attached to the first frame body 10.

By providing the first openings 21 on the vibrating diaphragm 20, the internal space of the speaker could communicate with the externals, allowing the air to flow in between. When the speaker is under operation, the heat generated by the driving module 200 or other components can be dissipated by the air flowing through the first opening 21 in terms of heat convection, thereby solving the problem of poor heat dissipation of conventional speakers.

Besides, as shown in FIG. 2 and FIG. 4, a plurality of covering members 30 are disposed on the vibrating diaphragm 20 and correspond to the first opening 21 of the vibrating diaphragm 20. The covering member 30 is disposed at the first opening 21 and comprises a plurality of through holes. In this embodiment, each of the covering members 30 comprises a second frame body 31 and a mesh 32. The second frame body 31 comprises a second opening 311 and is disposed around the first opening 21 so that the second opening 311 can be aligned with the first opening 21. In this embodiment, the center of the second opening 311 is aligned with the center of the first opening 21. The second frame body 31 comprises a pair of pad layers 312 overlappingly disposed. The mesh 32 is disposed between and is clamped and secured by the pad layers 312. For example, an adhesive can be applied between the pad layers 312. When the upper and lower pad layers 312 are adhered and secured, the mesh 32 would be clamped and secured therein, and the lower pad layer 312 would also be attached to the vibrating diaphragm 20 by adhesive. The pad layer 312 could be made of polyethylene terephthalate (PET). The plurality of through holes of the covering member 30 are implemented with the mesh pores of the mesh 32. The mesh 32 may be made of metal or plastic, and the size of the mesh pore can be determined according to the designing, which is not limited thereto. Since the first opening 21 is covered with the mesh 32, the internal space of the speaker still maintains communication with the external space, to achieve thermal convection and heat dissipation by air.

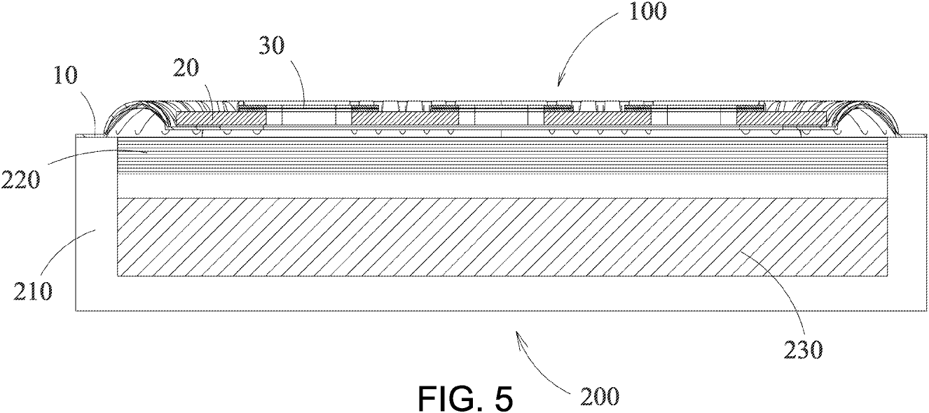

FIG. 5 is a cross-sectional view of a speaker of an embodiment of the present disclosure. In this embodiment, the speaker comprises a speaker vibration assembly 100 and a driving module 200. The speaker vibration assembly 100 is disposed at the driving module 200. The driving module 200 comprises a bracket 210, a coil 220, and a permanent magnet 23. The speaker vibration assembly 100 is supported by the bracket 210. The coil 220 is connected to the first frame body 10 of the speaker vibration assembly 100. The permanent magnet 230 is disposed in the bracket 210. When electric current passes through the coil 220, the coil 220 would be excited, and the magnetic field of the coil 220 would interact with the magnetic field of the permanent magnet 230. By changing the direction of the electric current in the coil 220, the direction of the magnetic field of the coil 220 can be changed to attract or repel the permanent magnet 230. In this way, the coil 220 and the first frame body 10 of the speaker vibration assembly 100 could reciprocate relative to the permanent magnet 230, so that the vibrating diaphragm 20 could reciprocate and vibrates the air to generate sound waves. Since the internal space and external space of the speaker are in communication with the mesh 32 through the first opening 21 of the vibrating diaphragm 20, the heat generated during the operation of the coil 220 can be dissipated by heat convection through the air.

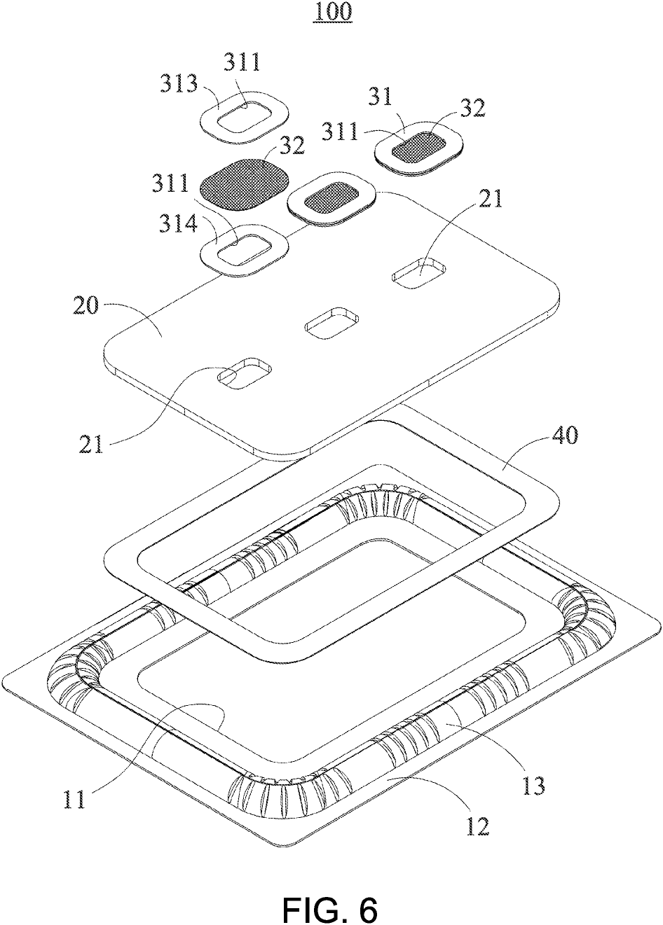

FIG. 6 is an exploded view of an electrical connector of another embodiment of the present disclosure. In this embodiment, the second frame body 31 of the covering member 30 comprises a top frame 313 and a bottom colloid 314. The top frame 313 and a mesh 32 are adhered and positioned on the vibrating diaphragm 20 through the bottom colloid 314. The top frame 313 could be made of polyethylene terephthalate (PET). The rest of the configuration of this embodiment is identical to the embodiment of FIG. 1 to FIG. 5.

In summary, embodiments of the present disclosure provide a speaker vibration assembly and a speaker. In the speaker vibration assembly, by providing a plurality of first openings on the vibrating diaphragm, and providing a covering member having a plurality of through holes on the first openings, the inner side of the speaker can be communicated with the outer side so that the air inside the speaker could flow to the outer side through the first opening and the plurality of through holes. Thus, the problem of poor heat dissipation of conventional speakers can be solved as the heat generated inside the speaker can be brought to the outside through the convection of the air.

Besides, the first opening of the speaker assembly is provided with a covering member having a plurality of through holes, so that the vibrating diaphragm could maintain structural continuity even a plurality of first openings are provided. When the vibrating diaphragm is driven by the driving module to vibrate, the tension of the vibrating diaphragm could be evenly applied to every position on the vibrating diaphragm. Thus, when the diaphragm is vibrating, every position on the vibrating diaphragm could be evenly displaced to avoid the generated sound wave being distorted compared to the predetermined sound wave that affects the quality of the sound output by the speaker.

It is to be understood that the term “comprises”, “comprising”, or any other variants thereof, is intended to encompass a non-exclusive inclusion, such that a process, method, article, or device of a series of elements not only comprise those elements but further comprises other elements that are not explicitly listed, or elements that are inherent to such a process, method, article, or device. An element defined by the phrase “comprising a ...” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A speaker vibration assembly, adapted to be driven by a driving module to vibrate, comprising:
a first frame body;
a vibrating diaphragm connected with the first frame body, the first frame body surrounding the vibrating diaphragm, the vibrating diaphragm comprising a first opening; and
a covering member disposed at the vibrating diaphragm and covering the first opening, the covering member comprising a plurality of through holes.

2. The speaker vibration assembly according to claim 1, wherein the covering member comprises a second frame body and a mesh; the second frame body is disposed at the vibrating diaphragm and comprises a second opening; the second frame body surrounds the first opening so that the second opening is aligned with the first opening; the mesh is disposed at the second opening of the second frame body and covers the first opening.

3. The speaker vibration assembly according to claim 2, wherein the second frame body comprises a pair of overlapped pad layers; the mesh is disposed between the pair of pad layers; the pair of pad layers are positioned at the vibrating diaphragm.

4. The speaker vibration assembly according to claim 2, wherein the second frame body comprises a top frame and a bottom colloid; the mesh is disposed between the top frame and the bottom colloid; the bottom colloid is attached to the vibrating diaphragm.

5. The speaker vibration assembly according to claim 1, wherein the number of first openings is multiple; the first openings are arranged linearly, curvedly, or in an array; the number of covering members is multiple; the covering members respectively cover the first openings.

6. The speaker vibration assembly according to claim 1, wherein the first frame body comprises a base and an annular bump; the base comprises a hollow part; the annular bump is disposed at the base and surrounds the hollow part and the vibrating diaphragm.

7. The speaker vibration assembly according to claim 6, wherein the cross sectional area of the annular bump is arc shaped.

8. The speaker vibration assembly according to claim 6, wherein an edge of the vibrating diaphragm abuts against the annular bump.

9. The speaker vibration assembly according to claim 1, further comprising an adhesive layer disposed between the vibrating diaphragm and the first frame body, the vibrating diaphragm being positioned on the first frame body through the adhesive layer.

10. A speaker, comprising:
a speaker vibration assembly according to claim 1; and
a driving module connected with the first frame body and configured to drive the first frame body to vibrate.

11. The speaker according to claim 10, wherein the covering member comprises a second frame body and a mesh; the second frame body is disposed at the vibrating diaphragm and comprises a second opening; the second frame body surrounds the first opening so that the second opening is aligned with the first opening; the mesh is disposed at the second opening of the second frame body and covers the first opening.

12. The speaker according to claim 11, wherein the second frame body comprises a pair of overlapped pad layers; the mesh is disposed between the pair of pad layers; the pair of pad layers are positioned at the vibrating diaphragm.

13. The speaker according to claim 11, wherein the second frame body comprises a top frame and a bottom colloid; the mesh is disposed between the top frame and the bottom colloid; the bottom colloid is attached to the vibrating diaphragm.

14. The speaker according to claim 10, wherein the number of first openings is multiple; the first openings are arranged linearly, curvedly, or in an array; the number of covering members is multiple; the covering members respectively cover the first openings.

15. The speaker according to claim 10, wherein the first frame body comprises a base and an annular bump; the base comprises a hollow part; the annular bump is disposed at the base and surrounds the hollow part and the vibrating diaphragm.

16. The speaker according to claim 15, wherein the cross sectional area of the annular bump is arc shaped.

17. The speaker according to claim 15, wherein an edge of the vibrating diaphragm abuts against the annular bump.

18. The speaker according to claim 10, wherein the speaker vibration assembly further comprises an adhesive layer disposed between the vibrating diaphragm and the first frame body, and the vibrating diaphragm is positioned on the first frame body through the adhesive layer.
